(19) United States
(12) Patent Application Publication
(10) Pub. No.: US 2012/0132180 A1
(43) Pub. Date: May 31, 2012

(54) MOTOR-DRIVEN IMPLEMENT HAVING IMPROVED CARBURETTOR PREHEATING

(75) Inventor: Christian VICK, Winsen (DE)

(73) Assignee: MAKITA CORPORATION, Anjo-shi (JP)

(21) Appl. No.: 13/302,636

(22) Filed: Nov. 22, 2011

(30) Foreign Application Priority Data
Nov. 30, 2010 (DE) 202010016017.0

(51) Int. Cl. F02M 15/02

(52) U.S. Cl. 123/545

(57) ABSTRACT

A motor-driven implement such as a hand-held tool or device for garden and landscape maintenance, includes an internal combustion engine having at least one cylinder and at least one carburettor, which is disposed in a carburettor chamber, is separated by an intermediate wall from an engine compartment. A housing is provided which at least partially encloses the engine compartment so that an upper part of the cylinder extends in the direction of the housing, and a fan wheel is further provided by which means air from the engine compartment can be introduced through a warm air opening in the intermediate wall into the carburettor chamber. For the motor-driven implement to have an improved carburettor pre-heating which enables easier operation, it is proposed that the warm air opening is disposed in the area of the intermediate wall which is disposed adjacently to the upper part of the cylinder.

The present invention relates to a motor-driven implement such as a chain saw, a hand grinder, a hand-held circular saw, a lawn mower, a lawn trimmer or another hand-held tool or device for garden and landscape maintenance, comprising an internal combustion engine having at least one cylinder and at least one carburettor, which is disposed in the carburettor chamber, which is separated by an intermediate wall from an engine compartment, where a housing is provided which at least partially encloses the engine compartment so that an upper part of the cylinder extends in the direction of the housing, wherein a fan wheel is further provided by which means air from the engine compartment can be introduced through a warm air opening in the intermediate wall into the carburettor chamber.

### PRIOR ART

Known from document DE 10 2009 008 055 A1 is a generic motor-driven implement that comprises a carburettor chamber for accommodating a carburettor and an engine compartment for accommodating a motor, where the carburettor chamber and the engine compartment are separated by an intermediate wall. An air opening is provided in the intermediate wall which can be opened or closed by means of a closure element as desired. If the closure element is closed, another opening must be provided for operating the internal combustion engine by which means the internal combustion engine can take the combustion air into the carburettor chamber via the carburettor.

Dust pre-separation of the intake air is frequently provided so that the air taken in by the internal combustion engine and therefore entering into the carburettor chamber is purified by means of the dust pre-separator. In order that the air can be additionally conveyed into the carburettor chamber, a fan wheel is provided which is operated, for example, by means of the internal combustion engine. The air is taken into the carburettor chamber via the fan wheel and the carburettor chamber must be sealed since otherwise, dust-laden air is taken in from outside. If the air is pressed into the carburettor chamber by means of the fan wheel, an excess pressure is formed in said chamber which inter alia ensures that no dust-laden air is taken in from outside. Furthermore, the best effect of the dust pre-separator can thereby be achieved.

If the motor-driven implement is operated at low outside temperatures, for example, in winter, the air entering into the carburettor chamber must be pre-heated so that the carburettor does not ice up and the motor-driven implement is out of operation. In this case it is known to pass air from the engine compartment into the carburettor chamber, since the air from the engine compartment is pre-heated. For this purpose, a warm air opening is provided in the intermediate wall between the engine compartment and the carburettor chamber, through which the heated air enters into the carburettor chamber. However, if the carburettor chamber is basically supplied via a cold air opening from the dust pre-separator at an excess pressure, the problem arises that the air which is introduced through the warm air opening in the intermediate wall into the carburettor chamber cannot then enter into the carburettor chamber if air is already pressed with an excess pressure via the dust pre-separator into the carburettor chamber. In order to nevertheless allow the intake of warm air through the warm air opening, it is provided, for example, to close the opening through which the air enters into the carburettor chamber from the dust pre-separator, by means of a closure element. Disadvantageously, the air can only then enter into the carburettor chamber through the warm air opening.

It is therefore the object of the present invention to provide a motor-driven implement having improved carburettor pre-heating, in particular it is the object of the present invention to provide a motor-driven implement having carburettor pre-heating which allows easier operation.

This object is solved starting from a motor-driven implement according to the preamble of claim 1 in conjunction with the characterising features. Advantageous further development of the invention are specified in the dependent claims.

### DISCLOSURE OF THE INVENTION

The invention includes the technical teaching that the warm air opening is disposed in the area of the intermediate wall which is disposed adjacently to the upper part of the cylinder.

The invention starts from the idea of providing a motor-driven implement having a warm air opening in the intermediate wall between the engine compartment and the carburettor chamber which is disposed in such a manner that air can also pass through the warm air opening into the carburettor chamber when air is already pressed into the carburettor chamber through a further opening from the dust pre-separator. An elevated ram pressure produced by the fan wheel is provided in the area between the upper part of the cylinder and the housing. Advantageously the housing is configured to be pressure-tight at least in the area in which the housing encloses the cylinder of the internal combustion engine. As a result, a ram pressure caused by the fan wheel is formed adjacently to the upper part of the cylinder between the cylinder and the housing and the accumulated air can act upon the warm air opening in such a manner than despite the excess pressure in the carburettor chamber, the air can enter into said chamber.

In the area of the upper part of the cylinder, a spark plug can be provided on said cylinder, where the warm air opening is advantageously disposed in the area of the spark plug or adjacently to the spark plug. A piston can be guided in a lifting manner in the cylinder, where the warm air opening is in particular disposed above the upper dead point of the piston adjacent to the cylinder. This results in particular in an arrangement of the warm air opening close below the highest point of the housing. The heated air is guided above the cylinder since the pressure of the air there is highest, which air is conveyed by the fan wheel into the area between the housing and the upper part of the cylinder. Since the air which has accumulated ahead of the warm air opening and therefore ahead of the inlet into the carburettor chamber forms the cooling air for the cylinder of the internal combustion engine, the cooling air only accumulates following a convective flow around the cylinder in order to cool the cylinder with the air and consequently heat the air by the cylinder. It has been shown that the pressure of the accumulated air at the location of the warm air opening according to the invention is greatest close below the housing so that the warm air can enter efficiently into the carburettor chamber through the warm air opening.

According to a further advantageous embodiment of the motor-driven implement, the housing can have means which create a flow of air from the fan wheel in the direction of the warm air opening and which are disposed inside on the housing. The means promote the accumulation of air in the engine compartment ahead of the warm air opening. If the warm air opening is opened, due to the means according to the invention a particularly large amount of air can enter into the carburettor chamber through the warm air opening without, for example, increasing the conveying capacity of the fan wheel. The means can thereby be disposed rigidly and permanently inside on the housing and the means are not intended to be operated manually.

For example, the means can comprise at least one and preferably a plurality of air guiding ribs and/or at least one and preferably a plurality of air guiding walls which are disposed in particular inside in the housing. The air guiding ribs and/or the air guiding walls can be disposed rigidly and permanently on the inner side of the housing. The air guiding ribs and/or air guiding walls are thereby disposed in such a manner that an elevated ram pressure of the air is formed between the upper part of the cylinder and the housing before entry into the warm air opening. In particular, the air-guiding ribs and/or air-guiding walls can form a funnel-like intake in the direction of the warm air opening so that the air moving over a larger region between the upper part of the cylinder and the housing can be deflected towards the warm air opening. Alternatively or additionally, the air guiding ribs and/or air guiding walls can be disposed on the cylinder of the internal combustion engine.

The ram pressure in the engine compartment before entry into the warm air opening can be greater than the pressure of the air located in the carburettor chamber. In addition to the warm air opening, a lower engine compartment opening can be provided in the intermediate wall, through which the air supplied by the fan wheel can be introduced into the carburettor chamber from the lower side of the engine compartment. By introducing air through the engine compartment opening into the carburettor chamber, a pressure is produced in the carburettor chamber that is greater than the ambient pressure. In particular, the air is introduced by means of the fan wheel through the engine compartment opening into the carburettor chamber, with the result that an excess pressure is produced in this chamber. Due to the arrangement of the warm air opening according to the invention and in particular due to the means provided in the housing which create the flow of air from the fan wheel in the direction of the warm air opening, the ram pressure in the engine compartment before entry into the warm air opening is increased in such a manner that this ram pressure is greater than the pressure of the air located in the carburettor chamber. As a result, the engine compartment opening need not be closed to convey warm air through the warm air opening from the engine compartment into the carburettor chamber.

If a dust pre-separator is provided, at least the air which can be introduced into the carburettor chamber through the engine compartment can be introduced into the carburettor chamber via the dust pre-separator, which air in particular has a lower temperature than the air which can be introduced through the warm air opening into the carburettor chamber. Both the air which enters into the carburettor chamber through the engine compartment opening and the air which enters into the carburettor chamber through the warm air opening can be supplied by the fan wheel, where the air can pass through the dust pre-separator in each case. Consequently, the air can on the one hand take the path directly through the engine compartment opening into the carburettor chamber without being heated at the cylinder, or the air takes the path through the warm air opening and is previously heated at the cylinder. The path taken by the air to pass from the dust pre-separator into the carburettor chamber can be determined by whether the warm air opening is closed or not.

Thus, a closure element can be provided which can be brought into a summer position in which the warm air opening is closed and which can be brought into a winter position in which the warm air opening is closed. The closure element can, for example, be actuated manually or electrically and it is sufficient to open the closure element in order to expose the warm air opening so that air can pass through the warm air opening from the engine compartment into the carburettor chamber without previously or simultaneously closing the engine compartment opening.

### BRIEF DESCRIPTION OF THE DRAWINGS

Further measures which improve the invention are presented in detail hereinafter jointly with the description of a preferred exemplary embodiment of the invention by reference to the figures. In the figures:

FIG. 1 shows an exemplary embodiment of motor-driven implement viewed in a first plane of intersection,

FIG. 2 shows the exemplary embodiment of the motor-driven implement according to FIG. 1 in a cross-sectional view according to a second plane of intersection and

FIG. 3 shows the exemplary embodiment of the motor-driven implement in yet another plane of intersection.

### PREFERRED EXEMPLARY EMBODIMENT OF THE INVENTION

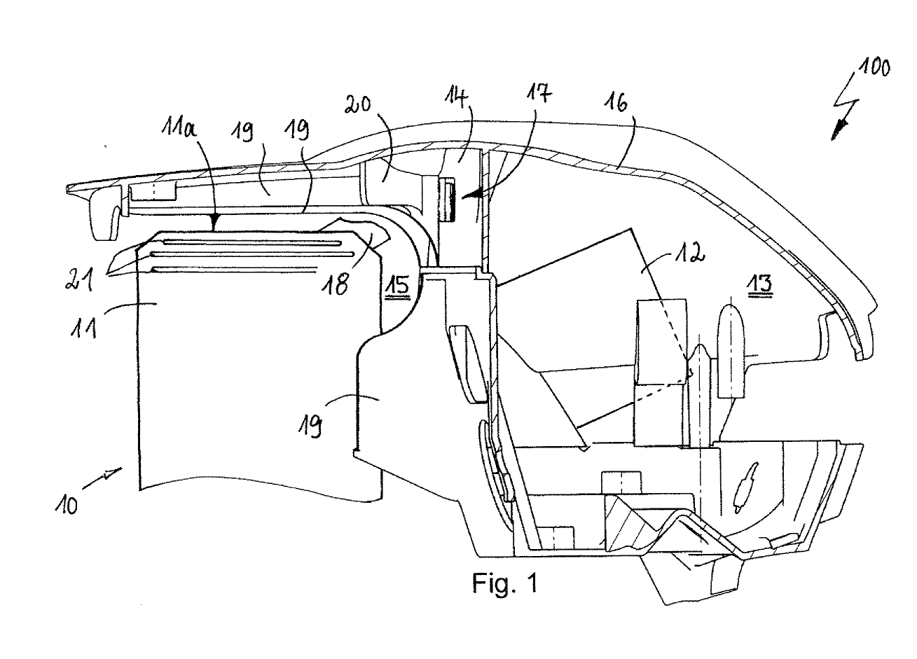

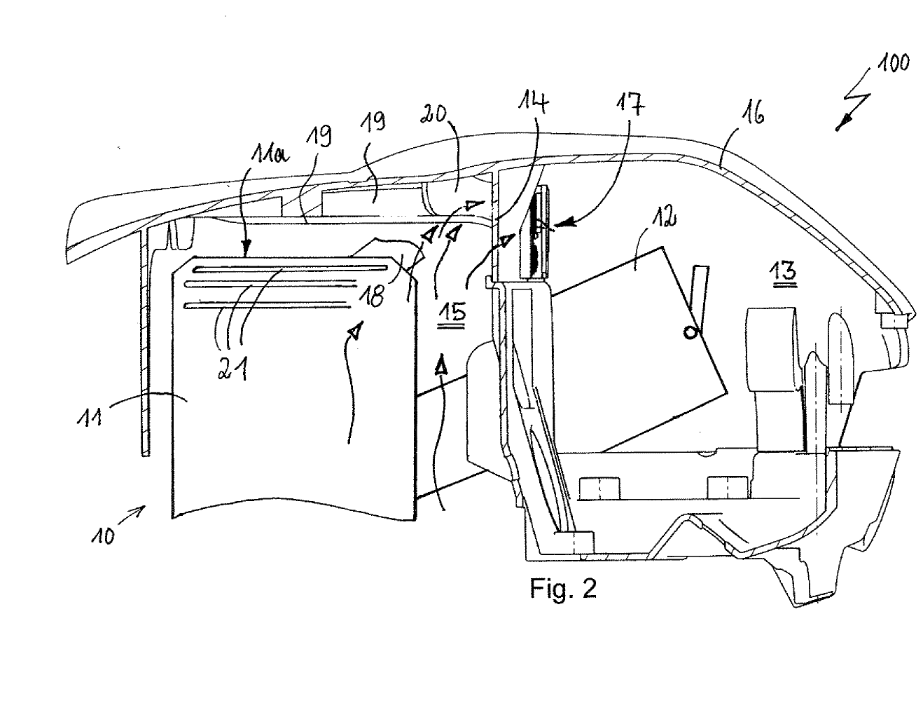

FIGS. 1 and 2 show an exemplary embodiment of a motor-driven implement 100 which can be designed as a chain saw, as a hand grinder, as a hand-held circular saw, as a lawn mower, as a lawn trimmer or as another hand-held tool or device for garden and landscape maintenance. The motor-driven implement 100 comprises an internal combustion engine 10 which is shown in the area of the cylinder 11. Further shown is a carburettor 12 which is disposed in a carburettor chamber 13 where the internal combustion engine 10 with the cylinder 11 is disposed in an engine compartment 15. The chambers 13 and 15 are formed by a housing 16 and separated from one another by an intermediate wall 14.

During operation of the internal combustion engine 10, this takes in combustion air through the carburettor 12 which is taken from the carburettor chamber 13. When the motor-driven implement 100 is operated at low temperatures, for example, in winter, the carburettor 12 can ice up at low air temperatures in the carburettor chamber 13 so that the motor-driven implement 100 can go out of operation. In order to counter this problem and provide air with an elevated temperature in the carburettor chamber 13, a warm air opening 17 is provided, which is inserted in the intermediate wall 14 and through which air can be transferred from the engine compartment 15 into the carburettor chamber 13. In this case, the air in the engine compartment 15 is provided by a fan wheel not shown in detail so that an excess pressure prevails in the engine compartment 15. When the warm air opening 17 is opened, air can initially pass from the engine compartment 15 into the carburettor chamber 13 provided that a lower pressure prevails in the carburettor chamber 13 than in the engine compartment 15.

When the motor-driven implement 100 is operated at higher temperatures, for example, in summer, the combustion air passes through an engine compartment opening, not shown in detail, from the fan wheel into the carburettor chamber 13. The air introduced into the carburettor chamber 13 is also supplied by the fan wheel so that the air is introduced through the engine compartment opening into the carburettor chamber at an elevated pressure. Consequently, the pressure ahead of the warm air opening 17 inside the engine compartment 15 must be so high that despite the pressurisation in the carburettor chamber 13 through the engine compartment opening air can be transferred from the engine compartment 15 through the warm air opening 17 into the carburettor chamber 13.

In the exemplary embodiments a warm air opening 17 is shown in an area of the intermediate wall 14 which is disposed adjacent to the upper part of the cylinder 11. It has been shown that the air conveyed by the fan wheel into the engine compartment 15 has the highest pressure in the area of the upper part of the cylinder 11. This effect is used by arranging the warm air opening 17 in the intermediate wall 14 in an area in the engine compartment 15 in which the air pressure is highest. This area is located in the area of the upper part of the cylinder 11, in particular between the upper part of the cylinder 11 and the housing 16.

The views in FIGS. 1 and 2 show in different planes of intersection the arrangement of the warm air opening 17 in the area of the upper part of the cylinder 11 in order to convey air heated by the cylinder 11 from the engine compartment 15 into the carburettor chamber 13. It has been shown that the pressure of the air entering into the carburettor chamber 13 through the warm air opening 17 is greater than the pressure of the air entering into the carburettor chamber 13 through the engine compartment opening from the engine compartment 15. As a result, by simply opening the warm air opening 17 without influencing the lower engine compartment opening, the carburettor chamber 13 can be supplied with heated air through the warm air opening 17 so that icing of the carburettor 12 at low outside temperatures can be avoided and an improved running of the internal combustion engine is possible.

A spark plug 18 is disposed in the upper part of the cylinder 11 and the warm air opening is disposed in the area of the spark plug 18 or adjacent to the spark plug 18. The air thereby flows past the cylinder 11 from the side facing away from the intermediate wall 14 and is thereby heated. When the air has passed the cylinder 11, it arrives at the point of maximum ram pressure at which the warm air opening 17 is located. The cylinder 11 is shown schematically with cooling ribs 21 and when the air emerges from the area of the cooling ribs 21 again, it then enters into the region ahead of the warm air opening 17 and can pass through this.

The housing 16 is shown with means which create a flow of the air from the fan wheel in the direction of the warm air opening 17 and which are arranged inside on the housing 16. The means are shown as air guiding ribs 19 and as air guiding walls 20 which are disposed directly in front of the warm air opening 17 on the side of the engine compartment 15 inside in the housing 16. The air guiding ribs 19 promote the air flow in the direction of the warm air opening 17. In particular, the air guiding ribs 19 run in a funnel shape in the direction of the warm air opening 17. The sectional view shows a profile of the air guiding ribs 19 along the air flow from the side of the cylinder 11 facing away from the intermediate wall 14 in the direction of the intermediate wall 14. Air guiding walls 20 are also provided which guide the air flowing along between the cylinder 11 and the housing 16 in the direction of the warm air opening 17. The pressure approximately below the highest point in the housing 16 is further increased by the air guiding ribs 19 and the air guiding walls 20 so that the ram pressure ahead of the warm air opening 17 reaches a pressure level that lies above the pressure level of the carburettor chamber 13 which is still supplied with air by the fan wheel through the engine compartment opening. As a result, the engine compartment opening need not first be closed to pass warm air through the warm air opening 17 into the carburettor chamber 13.

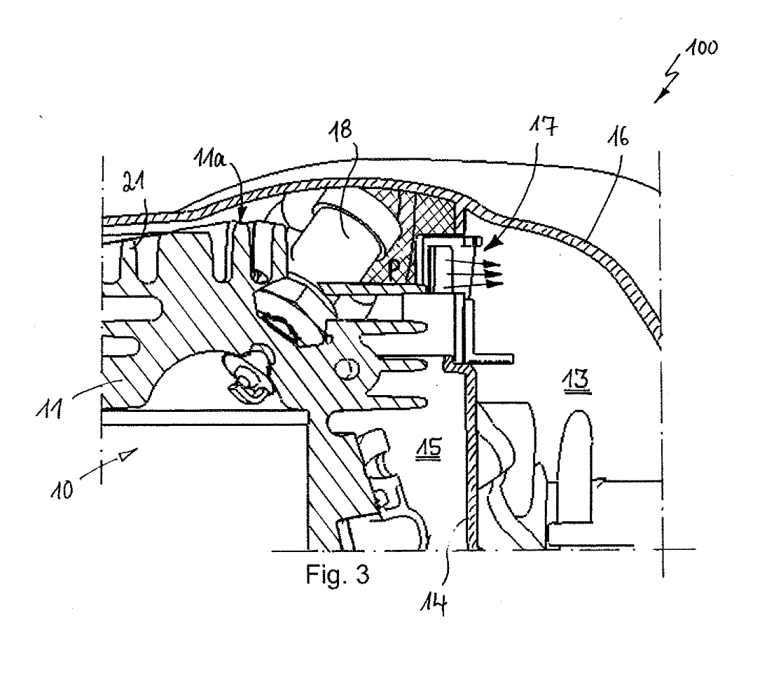

FIG. 3 shows in another cross-sectional view an exemplary embodiment of the motor-driven implement 100 comprising an internal combustion engine 10 which is shown in the area of the cylinder 11. Also shown in the sectional view is the housing 16 that is designed in one piece with the intermediate wall 14 which separates the carburettor chamber 13 from the engine compartment 15. Furthermore, the cylinder 11 is shown with a spark plug 18 and the warm air opening 17 is located in the immediate vicinity of the spark plug 18. The area between the upper part 11a of the cylinder 11 and the inner side of the housing 16 forms a flow channel in which air can flow past the cylinder 11 and which is favourably heated by cooling ribs 21 on the cylinder 11. When the air enters in the direction of the warm air opening 17, it reaches the highest pressure p there, characterised by a cross hatching.

The invention is not restricted in its execution to the preferred exemplary embodiment specified hereinbefore. On the contrary, a number of variants is feasible which make use of the solution presented in fundamentally different embodiments. All the features and/or advantages deduced from the claims, the description or the drawings, including constructive details or spatial arrangements, can be essential for the invention both for themselves and in various combinations. In particular, the housing 16 need not form the outer skin of the motor-driven implement 100 and a housing 16 can be provided which merely encloses the cylinder 11 in such a manner that a corresponding ram pressure of the air between the upper part 11a of the cylinder 11 and the housing 16 is formed ahead of the warm air opening 17.

### REFERENCE LIST

100 Motor-driven implement
10 Internal combustion engine
11 Cylinder
11a Upper part of cylinder
12 Carburettor
13 Carburettor chamber
14 Intermediate wall
15 Engine compartment
16 Housing
17 Warm air opening
18 Spark plug
19 Air guiding rib
20 Air guiding wall
21 Cooling ribs
p Air pressure

1. A motor-driven implement such as a chain saw, a hand grinder, a hand-held circular saw, a lawn mower, a lawn trimmer or another hand-held tool or device for garden and landscape maintenance, comprising an internal combustion engine having at least one cylinder and at least one carburettor, which is disposed in a carburettor chamber, which is separated by an intermediate wall from an engine compartment, wherein a housing is provided which at least partially encloses the engine compartment so that an upper part of the cylinder extends in the direction of the housing, wherein a fan wheel is further provided by which means air from the engine compartment can be introduced through a warm air opening in the intermediate wall into the carburettor chamber, wherein the warm air opening is disposed in the area of the intermediate wall which is disposed adjacently to the upper part of the cylinder.

2. The motor-driven implement according to claim 1, wherein in the area of the upper part of the cylinder, a spark plug is provided on said cylinder, wherein the warm air opening is disposed in the area of the spark plug or adjacently to the spark plug.

3. The motor-driven implement according to claim 1, wherein a piston is guided in a lifting manner in the cylinder, wherein the warm air opening is disposed at height above the upper dead point of the piston adjacent to the cylinder.

4. The motor-driven implement according to claim 1, wherein the housing has means which create a flow of air from the fan wheel in the direction of the warm air opening and which are disposed inside on the housing.

5. The motor-driven implement according to claim 4, wherein the means comprise at least one air guiding rib and/or at least one air guiding wall which are disposed in particular inside in the housing.

6. The motor-driven implement according to claim 1, wherein the air guiding ribs and/or the air guiding walls are disposed in such a manner that an elevated ram pressure of the air is formed between the upper part of the cylinder and the housing before entry into the warm air opening.

7. The motor-driven implement according to claim 1, wherein the ram pressure in the engine compartment before entry into the warm air opening is greater than the pressure of the air located in the carburettor chamber.

8. The motor-driven implement according to claim 1, wherein in addition to the warm air opening an engine compartment opening is provided, through which the air supplied by the fan wheel can be introduced into the carburettor chamber.

9. The motor-driven implement according to claim 8, wherein a dust pre-separator is provided, wherein at least the air which can be introduced into the carburettor chamber through the engine compartment can be introduced into the carburettor chamber via the dust pre-separator, which air in particular has a lower temperature than the air which can be introduced through the warm air opening into the carburettor chamber.

10. The motor-driven implement according to claim 1, wherein a closure element is provided which can be brought into a summer position in which the warm air opening is closed and which can be brought into a winter position in which the warm air opening is opened.
